(19) United States
(12) Patent Application Publication
(10) Pub. No.: US 2006/0237914 A1
(43) Pub. Date: Oct. 26, 2006

(54) Swirl-reversal abradable labyrinth seal

(75) Inventors: Jiming Li, Monroeville, PA (US); Pranabesh De Choudhury, Greensburg, PA (US)

Correspondence Address: THE WEBB LAW FIRM, P.C., 700 KOPPERS BUILDING, 436 SEVENTH AVENUE, PITTSBURGH, PA, 15219, US

(73) Assignee: ELLIOTT COMPANY, Jeannette, PA (US)

(21) Appl. No.: 10/560,800

(22) PCT Filed: Jun. 18, 2004
(86) PCT No.: PCT/US04/19496

§ 371 Date: May 12, 2006

Related U.S. Application Data
(60) Provisional application No. 60/480,394, filed on Jun. 20, 2003.

(51) Int. Cl. F16J 15/447

(52) U.S. Cl. 277/415

(57) ABSTRACT

An apparatus for restricting axial flow through the clearance between a rotating shaft and a seal stator comprises an abradable labyrinth seal and swirl-reversal vanes upstream of the labyrinth seal. The shaft comprises a first toothed axial section having a plurality of annular teeth, a second upstream toothed axial section having a few annular teeth from one to three, and a section therebetween having a cylindrical surface of diameter less than the outer edge of the teeth of the toothed sections, the swirl-reversing vanes being fastened to the stator seal between the toothed sections.

### BACKGROUND OF THE INVENTION

Centrifugal compressors are rotating machines. They are comprised of stationary portions referred to as stators and rotating portions known as rotors. The rotors are supported on journal bearings in the stator. Differential gas pressure in the axial direction along the shaft tends to cause leakage flow along the shaft from higher to lower pressure regions. This leakage flow is detrimental for various reasons. Hence, seals are positioned along the shaft to retard this leakage flow. In centrifugal compressors, use of labyrinth seals, and especially abradable labyrinth seals, are well known. Labyrinth seals provide a tortuous path along the shaft minimizing flow. Generally, labyrinth seals comprise a plurality of radial teeth extending from the stator or the shaft with a small radial clearance at the tips of the teeth. In order to make the clearance very small and yet to accommodate the unavoidable vibration of the shaft relative to the stator which would result in the bouncing contact between the tip of the labyrinth teeth and the surface opposing the teeth, the surface is made of an abradable material such that in use, and depending on the vibrations encountered, the tips of the labyrinth teeth cut away grooves providing an additional clearance.

One of the detriments of leakage flow through labyrinth seals is that it can be the cause of rotor instability and vibration. Gases flowing axially along the shaft may have a circumferential component referred to as a swirl. Labyrinth seals with strong gas swirl in the direction of rotation of the shaft can generate a destabilizing force that may induce rotor instability. This is primarily influenced by the swirl velocity at the entrance to the labyrinth seal. Vanes have been proposed for reducing the swirl in common labyrinth seals as explained, for example, in Miller U.S. Pat. No. 4,420,161. This invention is directed to the integration of swirl-reducing vanes and abradable labyrinth seals with teeth fixed to the stator.

### SUMMARY OF THE INVENTION

Briefly, according to this invention, there is provided an apparatus for restricting axial flow through the clearance between a rotating shaft and a seal stator and providing effective damping to improve rotor stability. The apparatus comprises an abradable labyrinth seal and swirl-reversing vanes upstream of the labyrinth seal. Preferably, the shaft comprises a first toothed axial section having a plurality of radially extending annular teeth and a second upstream toothed axial section having at least one radially extending annular tooth. Typically, the number of teeth in the second axial section is less than four. Between the first and second toothed sections, there is a cylindrical surface of diameter less than the diameter of the outer edges of the teeth. Fixed to the stator is a plurality of swirl-reversing vanes opposed to the cylindrical surface. Also fixed to the stator is a smooth abradable surface opposed to the first toothed axial section. Abradable materials used with teeth-on-shaft labyrinths allow a tighter clearance to restrict the axial flow more effectively. According to a preferred embodiment, the vanes have a v-shape with a generally v-shaped slot therebetween. The apex of the slot is pointed circumferentially in the direction of rotation whereby the axial gas flow swirling in the rotational direction of the shaft enters the slots and is redirected to exit swirling in the direction against the rotation of the shaft. In an alternate embodiment, the vanes have an arcuate shape with the top of the arc pointed in the direction of rotation of the shaft. The tooth upstream of the vanes has the function of delivering the swirling axial flow to the base of the vanes enabling the most effective swirl reversal.

### BRIEF DESCRIPTION OF THE DRAWINGS

Further features and other objects and advantages will become apparent from the following detailed description made with reference to the drawings in which:

FIG. 1 is a section view of an apparatus according to this invention;

FIG. 2 is a detailed section view illustrating main axial leakage flow and secondary axial leakage flow;

FIG. 3 is an unrolled schematic view of a portion of the swirl-reversal vane cascade on the inner diameter of the stator for illustrating the swirl reversal; and

FIGS. 4(A), 4(B), and 4(C) are views similar to FIG. 3 illustrating alternate vane cascade configurations.

### DESCRIPTION OF THE PREFERRED EMBODIMENTS

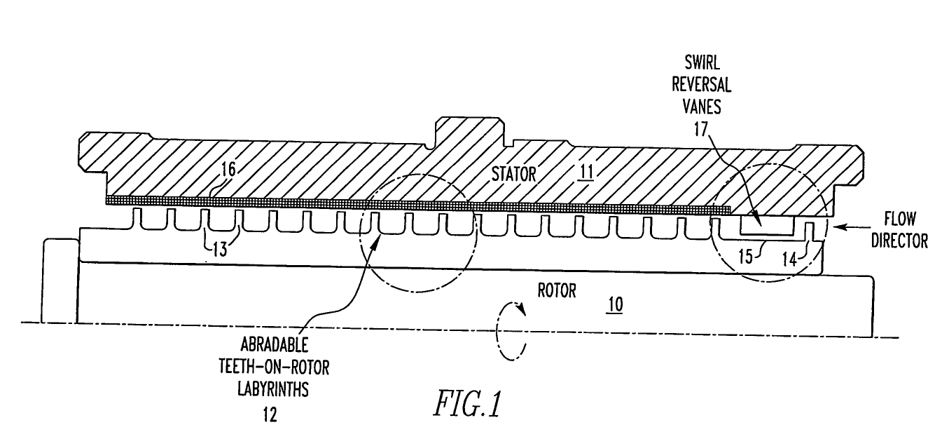

Referring to FIG. 1, the apparatus for restricting axial flow, according to this invention, comprises a rotor portion 10 and a stator seal portion 11. The rotor has a toothed section 12 comprising a labyrinth seal. There is a very small clearance between the tip of teeth 13 and the inner surface of the stator seal. The rotor has a second toothed section 14 upstream of the first toothed section having at least one tooth. Between the first and second toothed sections there is a section 15 that is a smooth cylindrical surface having a diameter less than the outer diameter of the tips of the labyrinth teeth. The surface of the stator radially outward of the plurality of teeth 13 in the first toothed section is coated with an abradable material 16. There may or may not be an abradable material radially outward of the second toothed section. If not, the clearance will be somewhat larger than being used with abradable materials. Swirl-reversal vanes 17 are fixed to the stator seal extending into cylindrical section 15 on the shaft.

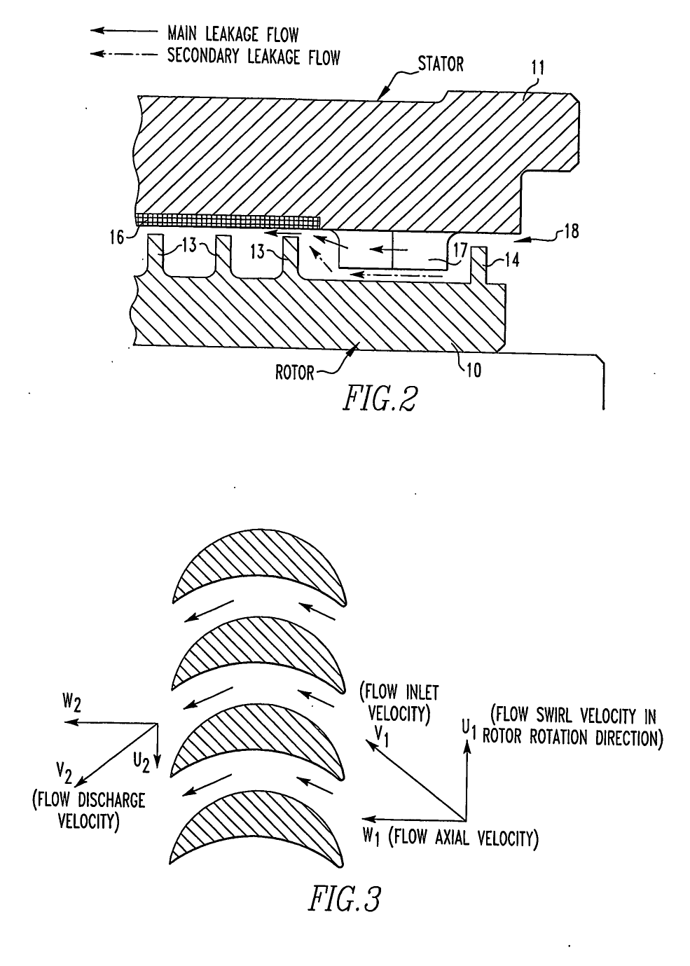

Referring to FIG. 2, arrow 18 indicates the direction of flow along the shaft. The tooth 14 causes the main leakage flow to pass through the swirl-reversal vanes 17. A minor or secondary leakage flow (indicated by a dashed line arrow) is not affected by the vanes. However, the secondary leakage flow is minor because of the existence and position of the vane 17.

Referring to FIG. 3, the operation of preferred swirl-reversal vanes, according to this invention, is described. The velocity of the inlet flow to the vanes VI has two components; namley, the axial velocity W₁ and the circumferential velocity U₁ in the direction of the rotor rotation. The vanes have a generally v-shape or arc shape with the apex or arch pointing in the direction of shaft rotation. The jet of leakage flow is confined and directed by the tooth 14 at the base of the vanes. The direction of the flow V₁ is generally parallel to the vanes at the entrance to the narrow path between the vanes. The curvature of the vanes reverses the leakage flow in the circumferential direction as illustrated by arrows V₂, U₂, and W₂.

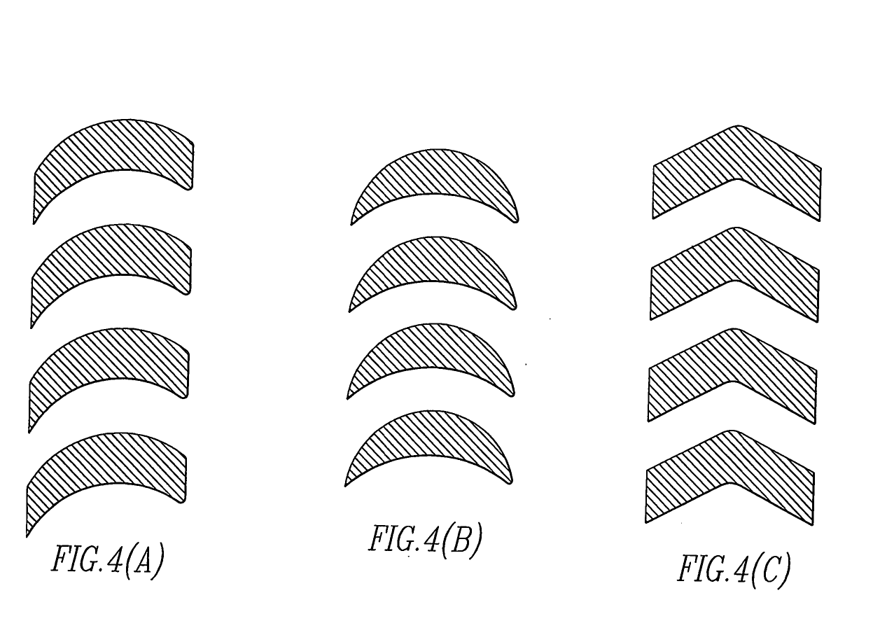

FIGS. 4(A), 4(B), and 4(C) illustrate alternate vane profiles suitable, according to this invention.

Having thus defined our invention in the detail and particularity required by the patent laws, what is desired protected by Letters Patent is set forth in the following claims.

The invention claimed is:

1. An apparatus for restricting axial flow through the clearance between a rotating shaft and a seal stator and providing effective damping to improve rotor stability, comprising:
an abradable labyrinth seal and swirl-reversal vanes upstream of the labyrinth seal.

2. An apparatus according to claim 1, wherein the shaft comprises a first toothed axial section having a plurality of annular teeth, a second upstream toothed axial section having a few annular teeth from one to three and a section therebetween having a cylindrical surface of diameter less than the outer edge of the teeth of the toothed sections, the swirl-reversing vanes being fastened to the stator seal between the toothed sections.

3. An apparatus according to claim 1 or 2, wherein there is a smooth abradable coating on surface of the stator seal radially outward of the first toothed section.

4. The apparatus according to claim 1 or 2, wherein the vanes have a generally v-shape with a generally v-shaped slot therebetween, the apex of the slot being circumferentially pointed in the direction of shaft rotation whereby the axial gas flow swirling in the rotational direction of the shaft enters the slots and is redirected to exit swirling in the direction against the rotation of the shaft.

5. The apparatus according to claim 4, wherein the vanes have an arcuate shape and the top of the arc is pointed in the direction of rotation of the shaft.

6. The apparatus according to claim 4, wherein the vanes have tapered ends.
